(19) United States
(12) Patent Application Publication
(10) Pub. No.: US 2026/0045874 A1
(43) Pub. Date: Feb. 12, 2026

(54) POWER CONVERTOR INCREASING DRIVING VOLTAGES OF SWITCHES

(71) Applicant: ANPEC ELECTRONICS CORPORATION, HSINCHU (TW)

(72) Inventors: PING-YU HUANG, HSINCHU (TW); FU-CHUAN CHEN, Hsinchu City (TW)

(21) Appl. No.: 18/961,370

(22) Filed: Nov. 26, 2024

(30) Foreign Application Priority Data
Aug. 12, 2024 (TW) 113130076

(51) Int. Cl. H02M 3/158; H02M 1/088; H02M 3/06

(52) U.S. Cl. CPC H02M 3/158; H02M 1/088; H02M 3/06

(57) ABSTRACT

A power convertor increasing driving voltages of switches is provided. The power convertor includes a high-side switch, a low-side switch, a driver circuit, a bootstrap capacitor and a charging circuit. The driver circuit is connected to a control terminal of the high-side switch and a control terminal of the low-side switch. A first terminal of the bootstrap capacitor is connected to the driver circuit and the charging circuit. The charging circuit charges the bootstrap capacitor, and the driver circuit drives the high-side switch and the low-side switch by using a voltage of a first terminal of the bootstrap capacitor.

### CROSS-REFERENCE TO RELATED PATENT APPLICATION

This application claims the benefit of priority to Taiwan Patent Application No. 113130076, filed on Aug. 12, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power convertor, and more particularly to a power convertor increasing driving voltages of switches.

### BACKGROUND OF THE DISCLOSURE

Power converters are indispensable for electronic devices. The power converters are used to adjust power and supply the adjusted power to the electronic devices. When a high-side switch and a low-side switch of the power convertor are n-type transistors such as n-type metal-oxide-semiconductor field effect transistors (NMOS), a bootstrap capacitor needs to be used for carrying out conduction of the high-side switch regardless of a value of an input voltage coupled to a first terminal of the high-side switch. However, when the input voltage being coupled to the power convertor has a low voltage value, a conduction efficiency of the high-side switch is poor.

### SUMMARY OF THE DISCLOSURE

In response to the above-referenced technical inadequacies, the present disclosure provides a power convertor increasing driving voltages of switches. The power convertor includes a high-side switch, a low-side switch, a driver circuit, a bootstrap capacitor and a charging circuit. A first terminal of the high-side switch is coupled to an input voltage. A first terminal of the low-side switch is connected to a second terminal of the high-side switch. A second terminal of the low-side switch is grounded. The driver circuit is connected to a control terminal of the high-side switch and a control terminal of the low-side switch. A first terminal of the bootstrap capacitor is connected to the driver circuit. A second terminal of the bootstrap capacitor is connected to the second terminal of the high-side switch. The charging circuit is connected to the first terminal of the bootstrap capacitor. The charging circuit is configured to charge the bootstrap capacitor. The driver circuit drives the high-side switch and the low-side switch by using a voltage of the first terminal of the bootstrap capacitor.

As described above, the present disclosure provides the power convertor increasing the driving voltages of the switches. In comparison with a bootstrap capacitor having a high capacitance outside a conventional power convertor, the bootstrap capacitor having a low capacitance is disposed inside the power convertor of the present disclosure. The bootstrap capacitor having the low capacitance only occupies a small space inside the power convertor of the present disclosure. Therefore, an area occupied by the power convertor of the present disclosure on a circuit board is not increased. When the input voltage of the power convertor of the present disclosure has a low voltage value, only the bootstrap capacitor having a low capacitance is charged for providing a high conduction efficiency of the high-side switch. When the low-side switch is intended to be turned on, the charged voltage of the bootstrap capacitor is provided to the low-side switch such that the low-side switch is turned on with the high conduction efficiency.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power convertor increasing driving voltages of switches according to a first embodiment of the present disclosure;

FIG. 2 is a circuit diagram of a power convertor increasing driving voltages of switches according to a second embodiment of the present disclosure;

FIG. 3 is a circuit diagram of a power convertor increasing driving voltages of switches according to a third embodiment of the present disclosure;

FIG. 4 is a circuit diagram of a power convertor increasing driving voltages of switches according to a fourth embodiment of the present disclosure;

FIG. 5 is a waveform diagram of signals of the power convertor increasing the driving voltages of the switches according to a fifth embodiment of the present disclosure;

FIG. 6 is a waveform diagram of signals of the power convertor increasing the driving voltages of the switches according to a sixth embodiment of the present disclosure;

FIG. 7 is a waveform diagram of signals of the power convertor increasing the driving voltages of the switches according to a seventh embodiment of the present disclosure;

FIG. 8 is a waveform diagram of signals of the power convertor increasing the driving voltages of the switches according to an eighth embodiment of the present disclosure; and

FIG. 9 is a waveform diagram of signals of the power convertor increasing the driving voltages of the switches according to the eighth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

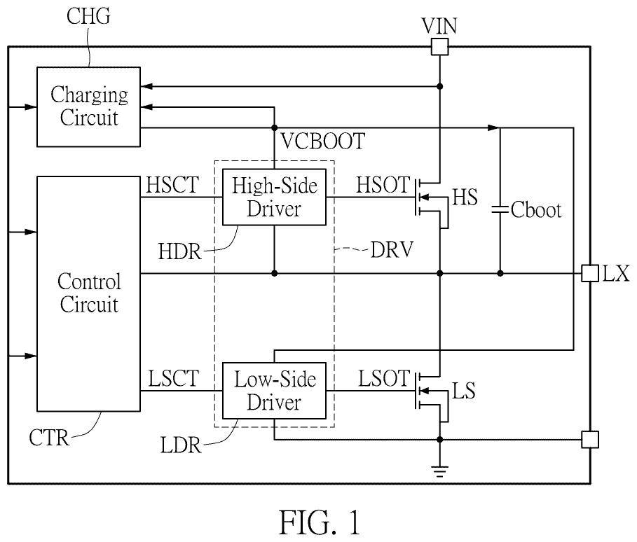

Reference is made to FIG. 1, which is a circuit diagram of a power convertor increasing driving voltages of switches according to a first embodiment of the present disclosure.

As shown in FIG. 1, in the first embodiment, the power convertor of the present disclosure includes a high-side switch HS, a low-side switch LS, a bootstrap capacitor Cboot, a charging circuit CHG and a driver circuit DRV.

The high-side switch HS and the low-side switch LS may be different types of transistors according to different practical requirements, and the present disclosure is not limited thereto.

A first terminal of the high-side switch HS is coupled to an input voltage VIN. A first terminal of the low-side switch LS is connected to a second terminal of the high-side switch HS. A second terminal of the low-side switch LS is grounded.

The driver circuit DRV may include a high-side driver HDR and a low-side driver LDR.

A positive power input terminal of the high-side driver HDR is connected to a first terminal of the bootstrap capacitor Cboot. A negative power input terminal of the high-side driver HDR is connected to the second terminal of the high-side switch HS.

A positive power input terminal of the low-side driver LDR is connected to the first terminal of the bootstrap capacitor Cboot. A negative power input terminal of the low-side driver LDR is connected to the second terminal of the low-side switch LS or is grounded.

The charging circuit CHG is connected to the first terminal of the bootstrap capacitor Cboot. A second terminal of the bootstrap capacitor Cboot is connected to the second terminal of the high-side switch HS.

A signal output terminal of the high-side driver HDR is connected to a control terminal of the high-side switch HS.

A signal output terminal of the low-side driver LDR is connected to a control terminal of the low-side switch LS.

It is worth noting that, a voltage between the control terminal (such as a gate terminal) and the second terminal of (such as a source terminal) of the high-side switch HS, and a voltage between the control terminal (such as a gate terminal) and the second terminal of (such as a source terminal) of the low-side switch LS, are decreased with a decrease in the input voltage VIN. At the same time, a resistance of the high-side switch HS and a resistance of the low-side switch LS are increased with the decrease in the input voltage VIN. As a result, the high-side switch HS and the low-side switch LS are not turned on successfully.

Therefore, the bootstrap capacitor Cboot is disposed inside the power convertor of the present disclosure. The charging circuit CHG is connected to the first terminal of the bootstrap capacitor Cboot. The first terminal of the bootstrap capacitor Cboot is further connected to the high-side driver HDR and the low-side driver LDR.

When the high-side switch HS is turned off and the low-side switch LS is turned on, the charging circuit CHG charges the bootstrap capacitor Cboot. As a result, a voltage of the control terminal of the high-side switch HS is pulled up by the charged voltage of the bootstrap capacitor Cboot. For example, the charging circuit CHG may be coupled to the input voltage VIN and may charge the bootstrap capacitor Cboot by using the input voltage VIN.

When the charging circuit CHG charges the bootstrap capacitor Cboot, a voltage VCBOOT of the first terminal of the bootstrap capacitor Cboot is used as an input supply voltage inputted to the positive power input terminal of the high-side driver HDR and the positive power input terminal of the low-side driver LDR.

Then, when the high-side switch HS is switched from an off-state to an on-state and the low-side switch LS is switched from an on-state to an off-state, the high-side driver HDR obtains and uses the charged voltage VCBOOT of the first terminal of the bootstrap capacitor Cboot for compensation of voltage drop loss of the high-side switch HS being turned on momentarily. As a result, the high-side switch HS is able to be turned on successfully.

The low-side driver LDR may also obtain the charged voltage VCBOOT of the first terminal of the bootstrap capacitor Cboot.

When the low-side driver LDR intends to turn on the low-side switch LS, the low-side driver LDR uses the charged voltage VCBOOT of the first terminal of the bootstrap capacitor Cboot to drive the low-side switch LS.

When the amount of a charging current that is supplied to the bootstrap capacitor Cboot by the charging circuit CHG is increased over time, the voltage VCBOOT of the first terminal of the bootstrap capacitor Cboot is increased.

When the input voltage VIN to which the high-side switch HS and the charging circuit CHG of the power convertor of the present disclosure are coupled is too low, the resistance of the high-side switch HS and the resistance of the low-side switch LS is too large. At this time, the high-side driver HDR uses the charged voltage VCBOOT of the first terminal of the bootstrap capacitor Cboot to increase the voltage between the second terminal and the control terminal of the high-side switch HS. In addition, the low-side switch LS uses the charged voltage VCBOOT to increase the voltage between the second terminal and the control terminal of the low-side switch LS. As a result, the high-side switch HS and the low-side switch LS are turned on successfully to allow sufficient current to flow though the high-side switch HS and the low-side switch LS. Therefore, the power converter of the present disclosure has a high operational efficiency.

If necessary, the power convertor of the present disclosure may further include a control circuit CTR.

An output terminal of the control circuit CTR is connected to a signal input terminal of the high-side driver HDR and a signal input terminal of the low-side driver LDR.

The control circuit CTR outputs a high-side control signal HSCT to the signal input terminal of the high-side driver HDR. The high-side driver HDR outputs a high-side on-time signal HSOT to the control terminal of the high-side switch HS according to the high-side control signal HSCT.

The control circuit CTR outputs a low-side control signal LSCT to the signal input terminal of the low-side driver LDR. The low-side driver LDR outputs a low-side on-time signal LSOT to the control terminal of the low-side switch LS according to the low-side control signal LSCT.

Working periods of a plurality of waveforms of the high-side on-time signal HSOT are conduction times/on-times of the high-side switch HS, and may be aligned with non-working periods of a plurality of waveforms of the low-side on-time signal LSOT (that are off times of the low-side switch LS).

Working periods of the plurality of waveforms of the low-side on-time signal LSOT are conduction times/on-times of the low-side switch LS, and may be aligned with non-working periods of the plurality of waveforms of the high-side on-time signal HSOT (that are off times of the high-side switch HS).

That is, the high-side switch HS and the low-side switch LS may be switched complementarily, but the present disclosure is not limited thereto. For example, when the low-side driver LDR turns on the low-side switch LS, the high-side driver HDR turns off the high-side switch HS. Under this condition, the charging circuit CHG charges the bootstrap capacitor Cboot to increase the voltage VCBOOT of the bootstrap capacitor Cboot for compensation of the voltage drop loss of the high-side switch HS being turned on momentarily. Then, when the low-side driver LDR turns off the low-side switch LS and the high-side driver HDR turns on the high-side switch HS, the high-side switch HS operates normally.

A node LX between the second terminal of the high-side switch HS and the first terminal of the low-side switch LS is used as an output terminal of the power convertor of the present disclosure, and is connected to a first terminal of an external inductor. A second terminal of the external inductor is connected to a load.

When the load must obtain power from the power converter of the present disclosure, an input current supplied from the input voltage VIN is able to successfully flow through the external inductor through the high-side switch HS of the power converter of the present disclosure being turned on to the load. Therefore, the load obtains sufficient power for operation from the power convertor of the present disclosure.

It is worth noting that, when the load transits from a heavy load or a medium load to a (super) light load, the power required by the load is reduced. At this time, the low-side switch LS must be turned on and the high-side switch HS must be turned off to reduce an output voltage VOUT of the power convertor of the present disclosure (that is a voltage of the second terminal of the external inductor) so as to reduce the power that is supplied to the load from the power convertor of the present disclosure.

When the low-side driver LDR intends to turn on the low-side switch LS and the voltage between the control terminal and the second terminal of the low-side switch LS is too low, the charging circuit CHG charges the bootstrap capacitor Cboot to increase the voltage VCBOOT of the bootstrap capacitor Cboot. As a result, the low-side driver LDR successfully turns on the low-side switch LS by using the increased voltage VCBOOT. At this time, a discharging current of the external inductor is able to successfully flow through the low-side switch LS being turned on to a ground. That is, the external inductor is able to be discharged successfully. Therefore, the output voltage VOUT of the output terminal of the power convertor of the present disclosure is reduced such that the load obtains appropriate power from the power convertor of the present disclosure.

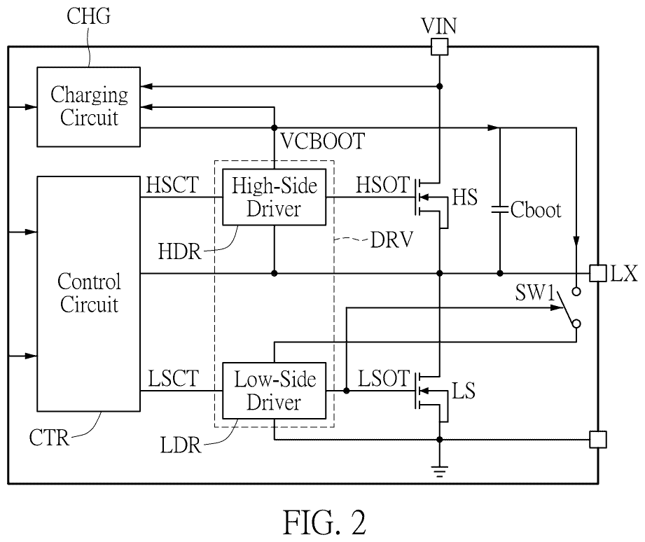

Reference is made to FIG. 2, which is a circuit diagram of a power convertor increasing driving voltages of switches according to a second embodiment of the present disclosure.

The descriptions of the second embodiment of the present disclosure that are the same as the descriptions of the first embodiment of the present disclosure are not repeated herein.

A difference between the second and first embodiments of the present disclosure is that, the power convertor of the second embodiment of the present disclosure further includes a low-side auxiliary switch SW1 as shown in FIG. 2.

A first terminal of the low-side auxiliary switch SW1 is connected to the first terminal of the bootstrap capacitor Cboot. A second terminal of the low-side auxiliary switch SW1 may be connected to a first power supply terminal of the low-side driver LDR. A control terminal of the low-side auxiliary switch SW1 may be connected to a driving output terminal of the low-side driver LDR.

In order to successfully turn on the low-side switch LS, the charging circuit CHG supplies the charging current to the bootstrap capacitor Cboot for charging the bootstrap capacitor Cboot, and the low-side driver LDR turns on the low-side auxiliary switch SW1. Then, the low-side driver LDR is able to successfully turn on the low-side switch LS by using the voltage VCBOOT of the charged bootstrap capacitor Cboot or a discharging current from the charged bootstrap capacitor Cboot.

Alternatively, when the low-side driver LDR turns on the low-side auxiliary switch SW1, the charging current supplied by the charging circuit CHG is divided into a first sub-charging current and a second sub-charging current. The first sub-charging current flows to the low-side driver LDR, and the low-side driver LDR drives the low-side switch LS by using the first sub-charging current. The second sub-charging current flows to the bootstrap capacitor Cboot for charging the bootstrap capacitor Cboot, and the high-side driver HDR turns on the high-side switch HS by using the charged voltage VCBOOT of the bootstrap capacitor Cboot.

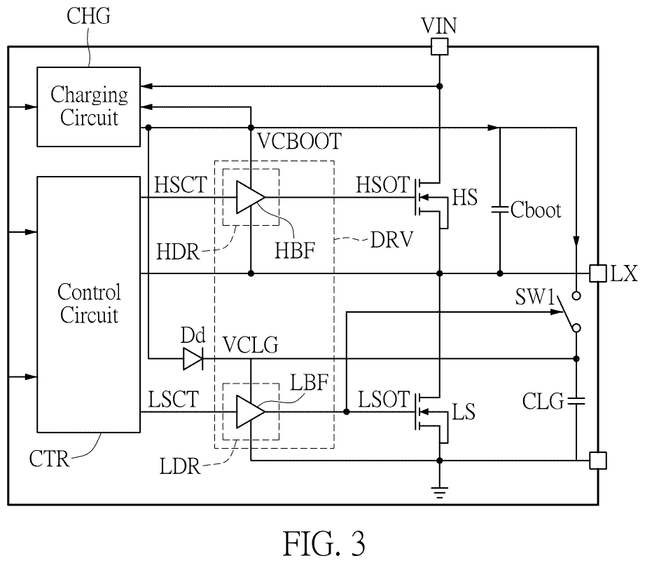

Reference is made to FIG. 3, which is a circuit diagram of a power convertor increasing driving voltages of switches according to a third embodiment of the present disclosure.

The descriptions of the third embodiment of the present disclosure that are the same as the descriptions of the first and second embodiments of the present disclosure are not repeated herein. Differences between the third and second embodiments of the present disclosure are described as follows.

As shown in FIG. 3, in the power convertor of the third embodiment of the present disclosure, the high-side driver HDR includes a high-side buffer HBF and the low-side driver LDR includes a low-side buffer LBF, but the present disclosure is not limited thereto.

The power convertor of the third embodiment of the present disclosure may further include a low-side auxiliary capacitor CLG.

A signal input terminal of the high-side buffer HBF is connected to a first output terminal of the control circuit CTR. A positive power input terminal of the high-side buffer HBF is connected to the first terminal of the bootstrap capacitor Cboot. A negative power input terminal of the high-side buffer HBF is connected to the second terminal of the high-side switch HS.

The high-side buffer HBF outputs the high-side on-time signal HSOT to the control terminal of the high-side switch HS according to the high-side control signal HSCT from the first output terminal of the control circuit CTR.

A signal input terminal of the low-side buffer LBF is connected to a second output terminal of the control circuit CTR. A positive power input terminal of the low-side buffer LBF is connected to the first terminal of the bootstrap capacitor Cboot and a first terminal of the low-side auxiliary capacitor CLG. A negative power input terminal of the low-side buffer LBF is connected to the second terminal of the low-side switch LS.

The low-side buffer LBF outputs the low-side on-time signal LSOT to the control terminal of the low-side switch LS according to the low-side control signal LSCT from the second output terminal of the control circuit CTR.

The first terminal of the low-side auxiliary capacitor CLG is connected to the second terminal of the low-side auxiliary switch SW1. A second terminal of the low-side auxiliary capacitor CLG is grounded.

The charging current supplied by the charging circuit CHG is divided into the first sub-charging current and the second sub-charging current.

The first sub-charging current among the charging current supplied by the charging circuit CHG flows to the bootstrap capacitor Cboot for charging the bootstrap capacitor Cboot. The voltage VCBOOT of the first terminal of the bootstrap capacitor Cboot is inputted to the positive power input terminal of the high-side buffer HBF.

When the high-side switch HS is turned on, the high-side buffer HBF uses the voltage VCBOOT of the first terminal of the bootstrap capacitor Cboot as an input voltage to drive the high-side switch HS for pulling up the voltage of the control terminal of the high-side switch HS to increase the voltage between the control terminal and the second terminal of the high-side switch HS to reach a high-side target voltage.

The second sub-charging current among the charging current supplied by the charging circuit CHG flows through the low-side auxiliary switch SW1 to the low-side auxiliary capacitor CLG for charging the low-side auxiliary capacitor CLG. A voltage VCLG of the first terminal of the low-side auxiliary capacitor CLG is inputted to the positive power input terminal of the low-side buffer LBF.

When the low-side switch LS is turned on, the low-side buffer LBF uses the voltage VCLG of the first terminal of the low-side auxiliary capacitor CLG as an input voltage to drive the low-side switch LS for pulling up a voltage of the control terminal of the low-side switch LS to increase the voltage between the control terminal and the second terminal of the low-side switch LS to reach a low-side target voltage.

That is, the charging circuit CHG may charge the bootstrap capacitor Cboot and the low-side auxiliary capacitor CLG for pulling up the voltage between the control terminal and the second terminal of the high-side switch HS and the voltage between the control terminal and the second terminal of the low-side switch LS at the same time.

If necessary, the power convertor of the present disclosure may further include a diode Dd as shown in FIG. 3.

An anode of the diode Dd is coupled to the input voltage VIN. A cathode of the diode Dd is connected to the first terminal of the low-side auxiliary capacitor CLG.

When the low-side switch LS is turned on, the input current supplied from the input voltage VIN may flow the diode Dd to the low-side auxiliary capacitor CLG for charging the low-side auxiliary capacitor CLG.

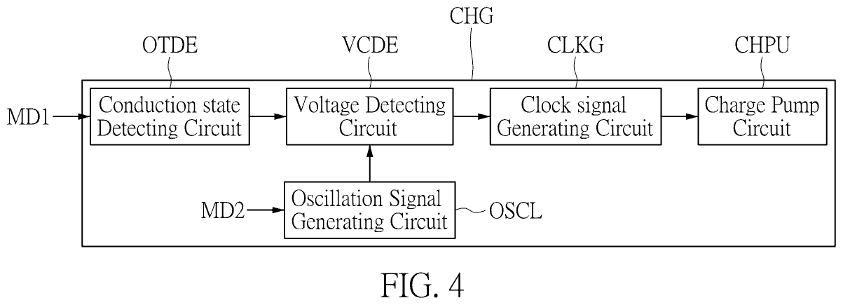

Reference is made to FIG. 4, which is a circuit diagram of a power convertor increasing driving voltages of switches according to a fourth embodiment of the present disclosure.

The charging circuit CHG shown in FIG. 1 to FIG. 3 may be the same as the charging circuit CHG shown in FIG. 4.

As shown in FIG. 4, the charging circuit CHG may include a conduction state detecting circuit OTDE, a voltage detecting circuit VCDE, an oscillation signal generating circuit OSCL, a clock signal generating circuit CLKG and a charge pump circuit CHPU, one or more of which may be omitted in practice.

The voltage detecting circuit VCDE may be connected to the conduction state detecting circuit OTDE, the oscillation signal generating circuit OSCL and the clock signal generating circuit CLKG. The charge pump circuit CHPU may be connected to the clock signal generating circuit CLKG.

The conduction state detecting circuit OTDE shown in FIG. 4 may be connected to the control terminal of the high-side switch HS and the control terminal of the low-side switch LS as shown in FIG. 1 to FIG. 3. The conduction state detecting circuit OTDE may detect a conduction state of the high-side switch HS and a conduction state of the low-side switch LS to output a conduction state detected signal.

The conduction state detecting circuit OTDE may, according to the conduction state of the high-side switch HS and the conduction state of the low-side switch LS, determine which one of a plurality of modes is an operation mode of the power convertor to output the conduction state detected signal. For example, the plurality of modes may include a pulse width modulation mode MD1 and a zero-cross mode MD2, but the present disclosure is not limited thereto.

The voltage detecting circuit VCDE shown in FIG. 4 may be connected to the conduction state detecting circuit OTDE shown in FIG. 4 and the first terminal of the bootstrap capacitor Cboot shown in FIG. 1 to FIG. 3. The voltage detecting circuit VCDE, according to the conduction state detected signal from the conduction state detecting circuit OTDE, determines a detection time within which the voltage VCBOOT of the first terminal of the bootstrap capacitor Cboot is detected.

The voltage detecting circuit VCDE may detect the voltage VCBOOT of the first terminal of the bootstrap capacitor Cboot in one or more of the plurality of modes. The voltage detecting circuit VCDE outputs a voltage detected signal according to the detected voltage VCBOOT of the first terminal of the bootstrap capacitor Cboot.

The oscillation signal generating circuit OSCL may output an oscillation signal.

When the power convertor operates in the zero-cross mode MD2, the high-side switch HS and the low-side switch LS are turned off. At this time, a current flowing through the high-side switch HS and a current flowing through the low-side switch LS reach a zero value. In order to reduce an area occupied by the bootstrap capacitor Cboot on a circuit board outside the power converter of the present disclosure, the bootstrap capacitor Cboot is moved from outside to inside of the power converter, which causes an increase in a voltage drop of the bootstrap capacitor Cboot inside the power converter in the zero-crossover mode MD2.

Therefore, when the power convertor operates in the zero-cross mode MD2, the oscillation signal generating circuit OSCL outputs the oscillation signal (having a constant frequency). The voltage detecting circuit VCDE, according to the oscillation signal, determines the detection time and a detection frequency of the voltage VCBOOT of the first terminal of the bootstrap capacitor Cboot.

For example, the voltage detecting circuit VCDE may detect the voltage VCBOOT of the first terminal of the bootstrap capacitor Cboot within a working period of each of a plurality of waveforms of the oscillation signal, and may not detect the voltage VCBOOT of the first terminal of the bootstrap capacitor Cboot within a non-working period of each of the plurality of waveforms of the oscillation signal.

Therefore, when the power convertor of the present disclosure operates in the zero-cross mode MD2, the charging circuit CHG may charge the bootstrap capacitor Cboot for pulling up the voltage between the control terminal and the second terminal of the high-side switch HS and the voltage between the control terminal and the second terminal of the low-side switch LS to appropriate voltage values. Then, the high-side switch HS and the low-side switch LS are able to be alternately turned on and operate normally.

When the power convertor of the present disclosure operates in the pulse width modulation mode MD1, the high-side switch HS and the low-side switch LS may be alternately turned on.

In the pulse width modulation mode MD1, the oscillation signal generating circuit OSCL may not output the oscillation signal, and may determine the detection time of the voltage VCBOOT of the first terminal of the bootstrap capacitor Cboot according to the conduction state of the high-side switch HS and the conduction state of the low-side switch LS.

When the power convertor of the present disclosure operates in one or more of the plurality of modes, the clock signal generating circuit CLKG may, according to the voltage detected signal from the voltage detecting circuit VCDE, set a charging time and a charging frequency of the bootstrap capacitor Cboot shown in FIG. 1 to FIG. 3 and a charging time and a charging frequency of the low-side auxiliary capacitor CLG shown in FIG. 2 and FIG. 3 to output a clock signal.

The charge pump circuit CHPU shown in FIG. 4 may be connected to the voltage detecting circuit VCDE shown in FIG. 4 and the first terminal of the bootstrap capacitor Cboot shown in FIG. 1 to FIG. 3.

The charge pump circuit CHPU may determine the charging time and the charging frequency of the bootstrap capacitor Cboot according to the clock signal from the clock signal generating circuit CLKG. For example, the charge pump circuit CHPU may charge the bootstrap capacitor Cboot within a working period of each of a plurality of pulse waves of the clock signal, and may not charge the bootstrap capacitor Cboot within a non-working period of each of the plurality of pulse waves of the clock signal.

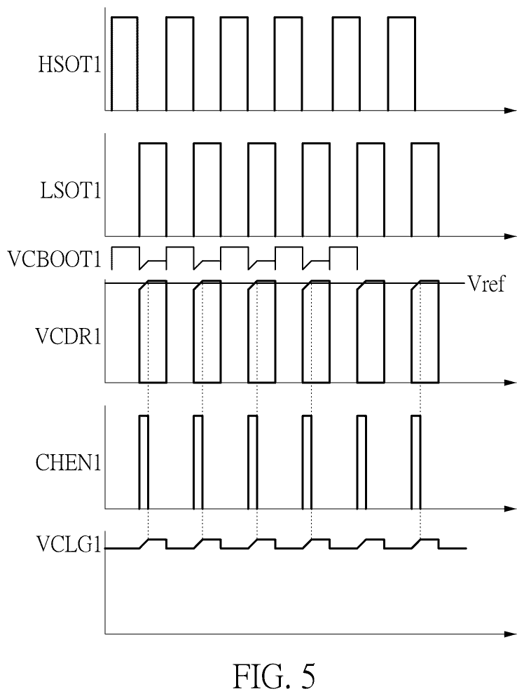

Reference is made to FIG. 5, which is a waveform diagram of signals of the power convertor increasing the driving voltages of the switches according to a fifth embodiment of the present disclosure.

The high-side on-time signal HSOT that is received from the high-side driver HDR by the high-side switch HS as shown in FIG. 1 to FIG. 3 may be the same as a high-side on-time signal HSOT1 shown in FIG. 5.

The high-side switch HS shown in FIG. 1 to FIG. 3 may be turned on within a working period of each of a plurality of waveforms of the high-side on-time signal HSOT1 shown in FIG. 5, and may be turned off within a non-working period of each of the plurality of waveforms of the high-side on-time signal HSOT1 shown in FIG. 5.

The low-side on-time signal LSOT that is received from the low-side driver LDR by the low-side switch LS as shown in FIG. 1 to FIG. 3 may be the same as a low-side on-time signal LSOT1 shown in FIG. 5.

The low-side switch LS shown in FIG. 1 to FIG. 3 may be turned on within a working period of each of a plurality of waveforms of the low-side on-time signal LSOT1 shown in FIG. 5, and may be turned off within a non-working period of each of the plurality of waveforms of the low-side on-time signal LSOT1 shown in FIG. 5.

It is worth noting that, the charging circuit CHG shown in FIG. 1 to FIG. 3 or the charge pump circuit CHPU of the charging circuit CHG shown in FIG. 4 may start charging the bootstrap capacitor Cboot shown in FIG. 1 to FIG. 3 from a time point of a rising edge of each of a plurality of pulse waves of a clock signal CHEN1 shown in FIG. 5.

A divided voltage of the voltage VCBOOT of the bootstrap capacitor Cboot shown in FIG. 1 to FIG. 3 may be the same as a divided voltage VCDR1 of the voltage VCBOOT1 shown in FIG. 5.

The voltage VCLG of the low-side auxiliary capacitor CLG shown in FIG. 2 and FIG. 3 may be the same as a voltage VCLG1 shown in FIG. 5.

When the low-side auxiliary switch SW1 is turned on as shown in FIG. 2 and FIG. 3, the charging circuit CHG shown in FIG. 1 to FIG. 3 or the charge pump circuit CHPU of the charging circuit CHG shown in FIG. 4 may charge the low-side auxiliary capacitor CLG shown in FIG. 2 and FIG. 3.

When the bootstrap capacitor Cboot and the low-side auxiliary capacitor CLG are charged, the voltage VCBOOT1 of the bootstrap capacitor Cboot and the voltage VCLG1 of the low-side auxiliary capacitor CLG are gradually increased as shown in FIG. 5. The voltage VCBOOT1 of the bootstrap capacitor Cboot is inputted to the high-side driver HDR (and the low-side driver LDR), and the voltage VCLG1 of the low-side auxiliary capacitor CLG is inputted to the low-side driver LDR (and the high-side driver HDR).

As shown in FIG. 5, the rising edges of the plurality of pulse waves of the clock signal CHEN1 are respectively aligned with rising edges of the plurality of waveforms of the low-side on-time signal LSOT1. The clock signal CHEN1 shown in FIG. 5 may be generated by the charging circuit CHG shown in FIG. 1 to FIG. 3 or the clock signal generating circuit CLKG of the charging circuit CHG shown in FIG. 4.

When the divided voltage VCDR1 of the voltage VCBOOT of the bootstrap capacitor Cboot is charged to a reference voltage Vref shown in FIG. 5, the charging circuit CHG shown in FIG. 1 to FIG. 3 or the charge pump circuit CHPU of the charging circuit CHG shown in FIG. 4 stops charging the bootstrap capacitor Cboot. As shown in FIG. 5, the divided voltage VCDR1 of the voltage VCBOOT of the bootstrap capacitor Cboot is charged to the reference voltage Vref at a time point of a falling edge of each of the plurality of pulse waves of the clock signal CHEN1.

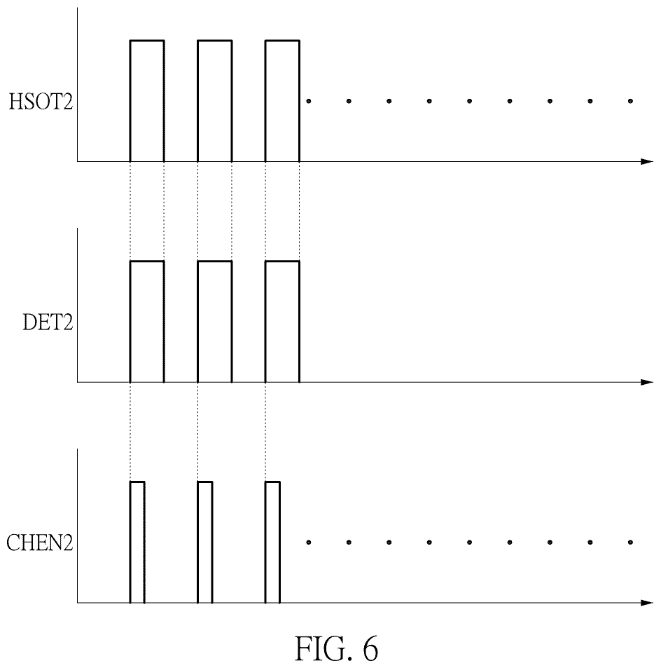

Reference is made to FIG. 6, which is a waveform diagram of signals of the power convertor increasing the driving voltages of the switches according to a sixth embodiment of the present disclosure.

The high-side on-time signal HSOT shown in FIG. 1 to FIG. 3 may be the same as a high-side on-time signal HSOT2 shown in FIG. 6.

For example, if a duty cycle of each of a plurality of waveforms of the high-side on-time signal HSOT2 shown in FIG. 6 is 70%, a duty cycle of each of the plurality of waveforms of the low-side on-time signal LSOT shown in FIG. 1 to FIG. 3 is 30%, but the present disclosure is not limited thereto.

The smaller the duty cycle of the low-side on-time signal LSOT is, the smaller the on-time of the low-side switch LS is. When the on-time of the low-side switch LS is too small, the charging time of the bootstrap capacitor Cboot and the charging time of the low-side auxiliary capacitor CLG as shown in FIG. 3 are too small. The voltage VCBOOT of the bootstrap capacitor Cboot and the voltage VCLG of the low-side auxiliary capacitor CLG are not charged to target voltages.

Therefore, when the low-side switch LS shown in FIG. 3 is switched from the on-state to the off-state and the high-side switch HS is switched from the off-state to the on-state, the charging circuit CHG shown in FIG. 3 may detect the voltage VCBOOT of the first terminal of the bootstrap capacitor Cboot, the voltage VCLG of the low-side auxiliary capacitor CLG or a combination thereof.

Working periods of a plurality of waveforms of a detection time signal DET2 shown in FIG. 6 are time intervals within which the charging circuit CHG detects the voltage VCBOOT of the first terminal of the bootstrap capacitor Cboot, the voltage VCLG of the low-side auxiliary capacitor CLG or the combination thereof. The working periods of the plurality of waveforms of the detection time signal DET2 are respectively aligned with working periods of the plurality of waveforms of the high-side on-time signal HSOT2.

When the charging circuit CHG determines that the detected voltage VCBOOT of the bootstrap capacitor Cboot or the detected voltage VCLG of the low-side auxiliary capacitor CLG is not yet charged to the target voltage at a rising edge of any one of the plurality of waveforms of the detection time signal DET2, the charging circuit CHG may charge the bootstrap capacitor Cboot within the on-time of the high-side switch HS (that is aligned with the off-time of the low-side switch LS).

Working periods of a plurality of pulse waves of a clock signal CHEN2 shown in FIG. 6 are time intervals within which the charging circuit CHG charges the bootstrap capacitor Cboot, and are respectively aligned with the working periods of the plurality of waveforms of the high-side on-time signal HSOT2 (that are the on-times of the high-side switch HS).

When the charging circuit CHG determines that the detected voltage VCBOOT of the bootstrap capacitor Cboot or the detected voltage VCLG of the low-side auxiliary capacitor CLG is charged to the target voltage at a time point falling within the working period of any one of the plurality of waveforms of the detection time signal DET2, the charging circuit CHG may stop charging the bootstrap capacitor Cboot.

That is, when the working period of the low-side on-time signal LSOT (that is the on-time of the low-side switch LS) or the duty cycle of the low-side on-time signal LSOT is too small, the charging circuit CHG may continually charge the bootstrap capacitor Cboot within a time interval being later than an ending time point of each of the working periods of the low-side on-time signal LSOT (that are the on-times of the low-side switch LS) to charge the detected voltage VCBOOT of the bootstrap capacitor Cboot to the target voltage.

Regardless of the duty cycle of the low-side on-time signal LSOT, in the power convertor of the present disclosure, the voltage VCBOOT of the bootstrap capacitor Cboot and the voltage VCLG of the low-side auxiliary capacitor CLG are able to be charged to the target voltages. As a result, the voltage between the control terminal and the second terminal of the high-side switch HS and the voltage between the control terminal and the second terminal of the low-side switch LS are pulled up such that the high-side switch HS and the low-side switch LS are able to be successfully turned on and operate normally.

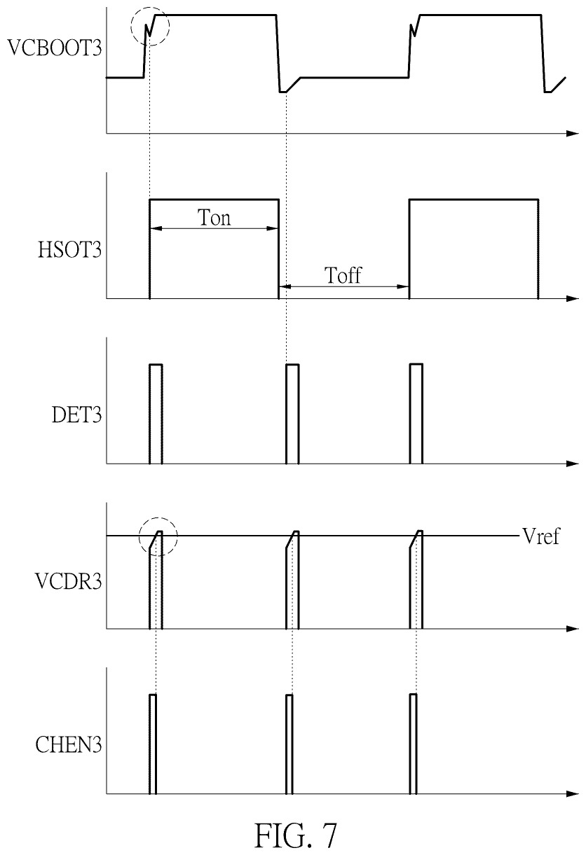

Reference is made to FIG. 7, which is a waveform diagram of signals of the power convertor increasing the driving voltages of the switches according to a seventh embodiment of the present disclosure.

The divided voltage of the voltage VCBOOT of the bootstrap capacitor Cboot shown in FIG. 1 to FIG. 3 may be the same as a divided voltage VCBOOT3 shown in FIG. 7. When the high-side switch HS is turned on momentarily, voltage drop is generated as circled by a dotted line on the divided voltage VCBOOT3 of the bootstrap capacitor Cboot in FIG. 7A.

The high-side on-time signal HSOT shown in FIG. 1 to FIG. 3 may be the same as a high-side on-time signal HSOT3 shown in FIG. 7.

A working period of each of a plurality of waveforms of the high-side on-time signal HSOT3 shown in FIG. 7 is an on-time Ton of the high-side switch HS shown in FIG. 1 to FIG. 3, and a non-working period of each of the plurality of waveforms of the high-side on-time signal HSOT3 is an off-time Toff of the high-side switch HS.

The charging circuit CHG shown in FIG. 1 to FIG. 3 may detect the voltage VCBOOT of the bootstrap capacitor Cboot within the on-time Ton and the off-time Toff of the high-side switch HS as shown in FIG. 7. Working periods of a plurality of waveforms of a detection time signal DET3 shown in FIG. 7 are time intervals within which the charging circuit CHG detects the voltage VCBOOT of the bootstrap capacitor Cboot.

When the charging circuit CHG determines that a divided voltage VCDR3 of the voltage VCBOOT of the detected bootstrap capacitor Cboot is not yet charged to the reference voltage Vref within the on-time Ton of the high-side switch HS, the charging circuit CHG may charge the bootstrap capacitor Cboot within the on-time Ton of the high-side switch HS. Working periods of a plurality of pulse waves of a clock signal CHEN3 shown in FIG. 7 may time intervals within which the charging circuit CHG charges the bootstrap capacitor Cboot.

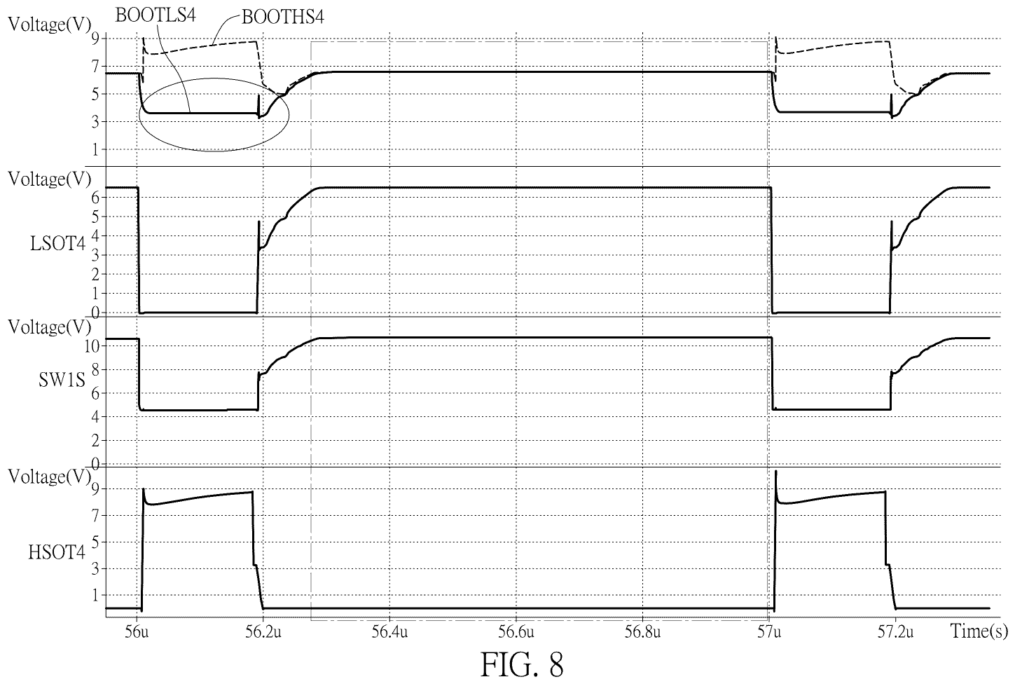

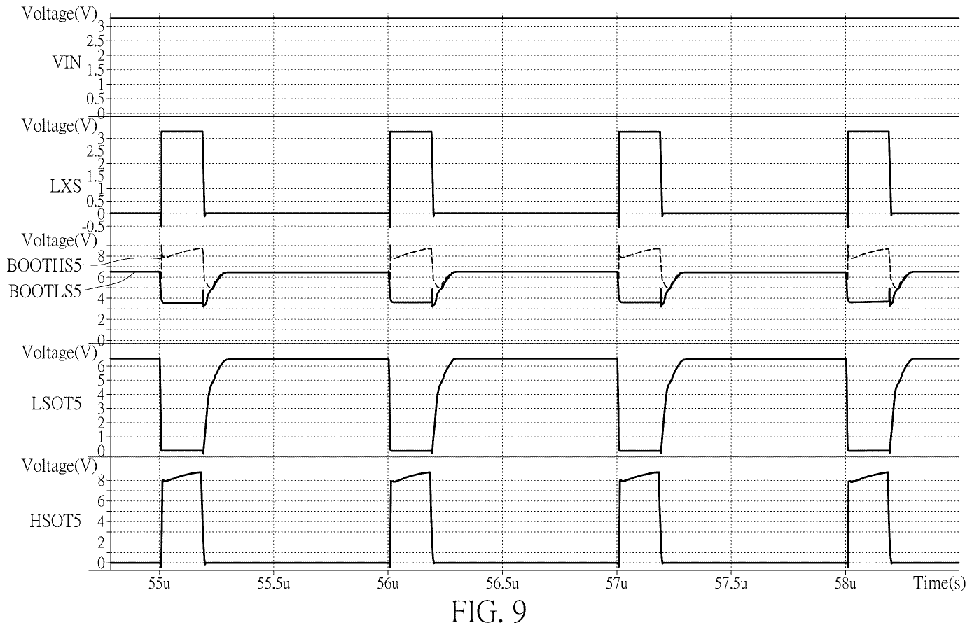

Reference is made to FIG. 8 and FIG. 9, which are waveform diagrams of signals of the power convertor increasing the driving voltages of the switches according to an eighth embodiment of the present disclosure.

A low-side on-time signal LSOT5 shown in FIG. 9 is amplified to form a low-side on-time signal LSOT4 shown in FIG. 8. Working periods of a plurality of waveforms of the low-side on-time signal LSOT5 shown in FIG. 9 may be the on-times of the low-side switch LS shown in FIG. 1 to FIG. 3.

A high-side on-time signal HSOT5 shown in FIG. 9 is amplified to form a high-side on-time signal HSOT4 shown in FIG. 8. Working periods of a plurality of waveforms of the high-side on-time signal HSOT shown in FIG. 9 may be the on-times of the high-side switch HS shown in FIG. 1 to FIG. 3.

A low-side driving voltage signal BOOTLS5 shown in FIG. 9 is amplified to form a low-side driving voltage signal BOOTLS4 shown in FIG. 8. A voltage of the low-side driving voltage signal BOOTLS5 is the voltage of the control terminal of the low-side switch LS.

A high-side driving voltage signal BOOTHS5 shown in FIG. 9 is amplified to form a high-side driving voltage signal BOOTHS4 shown in FIG. 8. A voltage of the high-side driving voltage signal BOOTHS5 is the voltage of the control terminal of the high-side switch HS.

A working period of each of a plurality of waveforms of an auxiliary switch conduction signal SW1S shown in FIG. 8 is an on-time of the low-side auxiliary switch SW1 shown in FIG. 2 and FIG. 3.

An output node voltage signal LXS shown in FIG. 8 is a voltage signal of the node LX between the second terminal of the high-side switch HS and the first terminal of the low-side switch LS as shown in FIG. 1 to FIG. 3.

When the low-side switch LS is turned on within the working periods of the plurality of waveforms of the low-side on-time signal LSOT5 (that are respectively aligned with non-working periods of a plurality of waveforms of the high-side on-time signal HSOT5), the low-side auxiliary switch SW1 shown in FIG. 2 and FIG. 3 is turned on as represented by the auxiliary switch conduction signal SW1S at a high level. At this time, the charging circuit CHG shown in FIG. 3 may charge the bootstrap capacitor Cboot and the low-side auxiliary capacitor CLG as shown in FIG. 3 at the same time.

The voltage of the low-side driving voltage signal BOOTLS5 that represents the voltage of the control terminal of the low-side switch LS shown in FIG. 1 to FIG. 3 and the voltage of the high-side driving voltage signal BOOTHS5 that represents the voltage of the control terminal of the high-side switch HS shown in FIG. 1 to FIG. 3 are quickly charged to the target voltages.

In particular, when the input voltage VIN to which the high-side switch HS (and the charging circuit CHG) of the power convertor of the present disclosure is coupled has a low voltage value such as 3.3V, the voltage between the control terminal and the second terminal of the high-side switch HS and the voltage between the control terminal and the second terminal of the low-side switch LS are still charged to the target voltages.

Therefore, when the input voltage VIN to which the high-side switch HS (and the charging circuit CHG) of the power convertor of the present disclosure is coupled has the low voltage value, the high-side switch HS and the low-side switch LS of the power convertor of the present disclosure are still quickly turned on with a high conduction efficiency.

In conclusion, the present disclosure provides the power convertor increasing the driving voltages of the switches. In comparison with a bootstrap capacitor having a high capacitance outside a conventional power convertor, the bootstrap capacitor having a low capacitance is disposed inside the power convertor of the present disclosure. The bootstrap capacitor having the low capacitance only occupies a small space inside the power convertor of the present disclosure. Therefore, an area occupied by the power convertor of the present disclosure on the circuit board is not increased. When the input voltage of the power convertor of the present disclosure has the low voltage value, only the bootstrap capacitor having the low capacitance is charged for providing the high conduction efficiency of the high-side switch. When the low-side switch is intended to be turned on, the charged voltage of the bootstrap capacitor is provided to the low-side switch such that the low-side switch is turned on with the high conduction efficiency.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power convertor increasing driving voltages of switches, comprising:
a high-side switch, wherein a first terminal of the high-side switch is coupled to an input voltage;
a low-side switch, wherein a first terminal of the low-side switch is connected to a second terminal of the high-side switch, and a second terminal of the low-side switch is grounded;
a driver circuit connected to a control terminal of the high-side switch and a control terminal of the low-side switch;
a bootstrap capacitor, wherein a first terminal of the bootstrap capacitor is connected to the driver circuit, and a second terminal of the bootstrap capacitor is connected to the second terminal of the high-side switch; and
a charging circuit connected to the first terminal of the bootstrap capacitor, and configured to charge the bootstrap capacitor;
wherein the driver circuit drives the high-side switch and the low-side switch by using a voltage of the first terminal of the bootstrap capacitor.

2. The power convertor according to claim 1, wherein the charging circuit is coupled to the input voltage, and charges the bootstrap capacitor by using the input voltage.

3. The power convertor according to claim 1, wherein, when the driver circuit turns on the low-side switch and turns off the high-side switch, the charging circuit charges the bootstrap capacitor.

4. The power convertor according to claim 1, wherein, when the charging circuit detects the first terminal of the bootstrap capacitor and determines that the voltage of the first terminal of the bootstrap capacitor or a divided voltage thereof is charged to reach a reference voltage, the charging circuit stops charging the bootstrap capacitor.

5. The power convertor according to claim 1, wherein, when the charging circuit detects the first terminal of the bootstrap capacitor and determines that the voltage of the first terminal of the bootstrap capacitor or a divided voltage thereof is not charged to reach a reference voltage yet, the charging circuit charges the bootstrap capacitor within an on-time of the high-side switch.

6. The power convertor according to claim 1, wherein the driver circuit includes:
a high-side driver connected to the control terminal of the high-side switch and the first terminal of the bootstrap capacitor, wherein the high-side driver outputs a high-side on-time signal to the control terminal of the high-side switch by using the voltage of the first terminal of the bootstrap capacitor; and
a low-side driver connected to the control terminal of the low-side switch and the first terminal of the bootstrap capacitor, wherein the low-side driver outputs a low-side on-time signal to the control terminal of the low-side switch by using the voltage of the first terminal of the bootstrap capacitor.

7. The power convertor according to claim 6, further comprising:
a control circuit connected to the high-side driver and the low-side driver, and configured to output a high-side control signal and a low-side control signal;
wherein the high-side driver outputs the high-side on-time signal according to the high-side control signal;
wherein the low-side driver outputs the low-side on-time signal according to the low-side control signal.

8. The power convertor according to claim 6, further comprising:
a low-side auxiliary switch, wherein a first terminal of the low-side auxiliary switch is connected to the charging circuit, and a second terminal and a control terminal of the low-side auxiliary switch are connected to the low-side driver.

9. The power convertor according to claim 8, further comprising:
a low-side auxiliary capacitor, wherein a first terminal of the low-side auxiliary capacitor is connected to the second terminal of the low-side auxiliary switch and the low-side driver, a second terminal of the low-side auxiliary capacitor is grounded, and the charging circuit charges the low-side auxiliary capacitor.

10. The power convertor according to claim 9, further comprising:
a diode, wherein an anode of the diode is coupled to the input voltage, and a cathode of the diode is connected to the first terminal of the low-side auxiliary capacitor.

11. The power convertor according to claim 1, wherein the charging circuit includes:
a voltage detecting circuit connected to the first terminal of the bootstrap capacitor, and detects the voltage of the first terminal of the bootstrap capacitor to output a voltage detected signal; and
a charge pump circuit connected to the voltage detecting circuit and the first terminal of the bootstrap capacitor, and configured to charge the bootstrap capacitor according to the voltage detected signal.

12. The power convertor according to claim 11, further comprising:
an oscillation signal generating circuit connected to the voltage detecting circuit and configured to output an oscillation signal;
wherein the voltage detecting circuit determines a frequency of detecting the voltage of the first terminal of the bootstrap capacitor according to the oscillation signal.

13. The power convertor according to claim 11, wherein the charging circuit further includes:
a clock signal generating circuit connected to the voltage detecting circuit and the charge pump circuit, and configured to output a clock signal according to the voltage detected signal;
wherein, when the power convertor operates one or more of a plurality of modes, the charge pump circuit determines a charging time of the bootstrap capacitor according to the clock signal.

14. The power convertor according to claim 11, wherein the charging circuit further includes:
a conduction state detecting circuit connected to the control terminal of the high-side switch, the control terminal of the low-side switch and the voltage detecting circuit, and configured to detect a conduction state of the high-side switch and a conduction state of the low-side switch to output a conduction state detected signal;
wherein the conduction state detecting circuit, according to the conduction state detected signal, determines a detection time within which the voltage of the first terminal of the bootstrap capacitor is detected.

15. The power convertor according to claim 14, wherein the conduction state detecting circuit, according to the conduction state of the high-side switch and the conduction state of the low-side switch, determines an operation mode of the power convertor to output the conduction state detected signal.
